(19) United States
(12) Patent Application Publication
(10) Pub. No.: US 2015/0081553 A1
(43) Pub. Date: Mar. 19, 2015

(54) Electronic Funds Transfer Consumer Authorization Verification System

(71) Applicant: BC INVESTMENTS & LEASING, INC., Fargo, ND (US)

(72) Inventor: Bryan J. Smith, Fargo, ND (US)

(73) Assignee: BC INVESTMENTS & LEASING, INC.

(21) Appl. No.: 14/489,106

(22) Filed: Sep. 17, 2014

Related U.S. Application Data
(60) Provisional application No. 61/878,750, filed on Sep. 17, 2013.

(51) Int. Cl. G06Q 20/10; G06Q 20/02; G06Q 20/16; G06Q 20/40

(52) U.S. Cl. CPC G06Q 20/10; G06Q 20/401; G06Q 20/023; G06Q 20/16
USPC 705/44

(57) ABSTRACT

An electronic funds transfer consumer authorization verification system for efficiently proving that a consumer authorized a financial transaction via an ACH network. The electronic funds transfer consumer authorization verification system generally includes accepting by a business an authorization from a consumer to debit and/or credit the consumer's financial account in a specified amount via an ACH network, communicating the ACH detailed record for the ACH transaction along with a transaction data file from the business to a third-party payment processor, and communicating to the business a transaction key associated with both the ACH detailed record and the transaction data file. The transaction data file is an image data file that may be comprised of an ACH authorization signature or statement by the consumer authorizing the ACH transaction, a copy of the identification documents for the consumer and/or state licensing information for the business.

### CROSS REFERENCE TO RELATED APPLICATIONS

I hereby claim benefit under Title 35, United States Code, Section 119(e) of U.S. provisional patent application Ser. No. 61/878,750 filed Sep. 17, 2013. The 61/878,750 application is currently pending. The 61/878,750 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an electronic funds transfer authentication system and more specifically it relates to an electronic funds transfer consumer authorization verification system for efficiently proving that a consumer authorized a financial transaction via an ACH network.

2. Description of the Related Art

Any discussion of the related art throughout the specification should in no way be considered as an admission that such related art is widely known or forms part of common general knowledge in the field.

Electronic funds transfer is the electronic transfer of money from one account to another account, either within a single financial institution or across multiple institutions through computer-based systems. Electronic funds transfer is comprised of various financial transactions such as credit card payments, direct deposit payroll payments, direct debit payments (a.k.a. electronic checks), electronic bill payment, and wire transfers. There are four main types of electronic funds transfer currently available for transferring money to consumers: bank wire transfers, cash wire transfers, interbank transfers, and automated clearing house (ACH) transfers.

Bank wire transfers are one of the fastest ways to send money because there is an agreement setup between the banks allowing for the transfer to take place. Bank wire transfers can take place the same day (sometimes within minutes) because they are a bank-to-bank transaction (without using a clearinghouse) that allows money to move from Bank Account A directly to Bank Account B. When a wire transfer occurs, the account holders and the amount of money in each account are verified to ensure a fast, reliable and secure transaction. In the United States, domestic wire transfers are governed by Federal Regulation J and by Article 4A of the Uniform Commercial Code. In addition, domestic bank to bank wire transfers are conducted through the Fedwire system which uses the Federal Reserve System and its assignment of routing transmit number to uniquely identify each bank. While wire transfers are fast, reliable and secure, the financial institutions typically charge a fee for transferring and receiving the funds (e.g. $20 to $35 to send a wire transfer and $10 to $20 to receive a wire transfer).

Cash wire transfers do not involve sending money between bank accounts, but instead involve receiving cash from a sender at Location A of a business and providing cash to a recipient at Location B of the same business. In a cash wire transfer, an individual physically provides cash to a business (e.g. MONEYGRAM®, WESTERN UNION®) at Location A and pays a fee. The business then verifies the cash transfer to Location B and then Location B provides the cash to the recipient. A typical cash wire transfer can take as little as 10 minutes making them a fast method of transferring cash. While cash wire transfers are fast, the business performing the cash wire transfer typically charges a fee of between $10 to $25 per transfer. In addition, the sender and receiver of the cash must both be physically present at the respective location of the business performing the cash wire transfer. Finally, cash wire transfers are susceptible to fraud since the recipient can provide a false identity. Interbank transfers are similar to bank wire transfers with the exception that the transfer occurs through an interbank network (a.k.a. ATM consortium or ATM network). In addition, interbank transfers typically utilize a third-party (e.g. FISERV®) that controls the transfer of funds between various different financial institutions that are part of the interbank network. Interbank transfers are commonly utilized for debit card payments and cash withdrawals. The main advantage of interbank transfers is the funds transfer is not processed by Fedwire making them faster than a bank wire transfer. Another advantage of interbank transfers is they are handled automatically within the interbank network making the transaction fee significantly lower than a bank wire transfer (typically around $1 per transaction). The main problem with an interbank transfer is that both financial institutions must be a member of the interbank network for the transfer of funds to occur whereas the ACH system does not have this limitation. Hence, if a financial institution is not a member of the interbank network, they are not able to transfer or receive funds via the interbank network.

An ACH transaction is accomplished with the help of an “automated clearing house” (e.g. the Federal Reserve or the Electronic Payments Network a.k.a. EPN which is operated by The Clearing House Payments Company) and is not performed directly as with wire transfers. The automated clearing house is basically an electronic network for financial transactions that processes large volumes of credit and debit transactions in batches. Common types of ACH transactions include online bill payment, mortgage and loan repayment, debit card payment, payday loan advances, payday loan payments by consumers, and direct deposit of payroll. ACH payments are electronic payments that are created when a consumer gives a business or an “originator” authorization to debit from (or credit to) the consumer's financial account (e.g. checking account or savings account) for the purpose of bill payment (or deposit). The debit and credit transactions are batched together into an ACH batch and are electronically sent to the clearing house. Additionally, banks receive their ACH transactions in ACH batches which are not processed single transactions. The batch transfer process of money via ACH simplifies the process because each individual transaction does not need individual attention because it is automated. Because ACH transactions do not require individual attention, the transfer fee is significantly less than a wire fee. While ACH transactions are less expensive than wire transfers, the recipient of the money must wait for the batch to be process which can take between 1 to 3 days.

Consumers who choose ACH payment must first authorize the business to debit or credit their financial account for a financial amount (e.g. the amount of a payment due, the amount of a consumer loan to receive). The consumer authorization must conform to the requirements of the ACH Operating Rules (see www.nacha.org) and must be either written and signed, or electronically displayed. A third party processor (e.g. INTERCEPT CORPORATION, PAYPAL) receives the ACH payment information from the business and then submits the ACH payment information to an originating depository financial institution (ODFI) by electronic transmission over a secure connection. The ODFI processes the ACH payment information and electronically delivers the information to the automated clearing house such as the Federal Reserve or EPN. The automated clearing house then electronically distributes the ACH items to the consumer's bank referred to as the receiving depository financial institution (RDFI). The automated clearing house deposits money for a credit transaction from the account at the ODFI or RDFI and withdraws money for a debit transaction from the account at the RDFI or ODFI. Periodic bank statements will reflect the ACH funds transfer. If a consumer debit results in a return for insufficient funds, closed bank account or other reason, transaction amounts are reversed to make them whole. Returns volumes that exceed thresholds set by the Federal government can result in termination of a business's ability to process transactions.

In business to consumer transactions, ACH transactions are a preferred system for transferring funds due to the low transactional cost. There are several types of ACH transactions between a business and a consumer. One type of ACH transaction is where the consumer requests funds to be deposited in their financial account (e.g. a consumer advance). Another type of ACH transaction is where the consumer requests funds to be withdrawn from the consumer's financial account (e.g. paying a bill or monies otherwise owed).

One of the problems with using the ACH system to transfer funds to or from a consumer with respect to a business is that the business is unable to attach the consumer's authorization to the ACH transaction thereby inherently creating a risk for the business that the ACH transaction will be returned because the consumer (or another party) disputes that it was authorized. In addition, if there is a question as to whether or not a consumer authorized an ACH transaction, the RDFI or ODFI must contact the business or third party processor to request evidence of the consumer's authorization (e.g. faxing a signed copy of an authorization by the consumer) which is time consuming and labor intensive. Another problem with using the ACH system to transfer funds to or from a consumer with respect to a business is that there is no verification system to determine if the business is authorized to do business in the consumer's state thereby exposing the business and the third party processor to unnecessary returns.

Because of the inherent problems with the related art, there is a need for a new and improved electronic funds transfer consumer authorization verification system for efficiently proving that a consumer authorized a financial transaction via an ACH network.

### BRIEF SUMMARY OF THE INVENTION

The invention generally relates to an electronic funds transfer authentication system which includes accepting by a business an authorization from a consumer to debit and/or credit the consumer's financial account in a specified amount via an ACH network, communicating the ACH detailed record for the ACH transaction along with a transaction data file from the business to a third-party payment processor, and communicating to the business a transaction key associated with both the ACH detailed record and the transaction data file. The transaction data file is an image data file that may be comprised of an ACH authorization signature or statement by the consumer authorizing the ACH transaction, a copy of the identification documents for the consumer and/or state licensing information for the business.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating the overall communications of the present invention via one or more telecommunications networks.

FIG. 2 is a block diagram illustrating the communications of information for the present invention where a third-party processor has a separate processor financial institution.

FIG. 3 is a block diagram illustrating the communications of information for the present invention where the third-party processor is the same as the processor financial institution.

FIG. 4 is a flowchart illustrating the overall functionality of the present invention.

FIG. 5 is a database table for a database used by the third-party payment processor illustrating the connection of each ACH entry detail record with one or more consumer data files using a common transaction key.

FIG. 6 illustrates an overview of the systems involved as they would apply to the third-party payment system, according to an embodiment of the invention.

FIG. 7 is a flowchart of data flows for the documents sent by the business proving they are licensed to do business in the state suggested, according to an example embodiment of the invention.

FIG. 8 is a flowchart of data flows for the setup of the envelope which contains information related to the business-to-consumer transaction and the authorization of each transaction, according to an example embodiment of the invention.

FIG. 9 is a flowchart of data flows for the advancement of money for the business-to-consumer transaction through the third-party payment processor system and out to the ACH payments network, according to an example embodiment of the invention.

FIG. 10 is a flowchart of data flows for the collection of money for the business-to-consumer transaction through the third-party payment processor system and out to the ACH payments network, according to an example embodiment of the invention.

FIG. 11 is a flowchart of data flows for the validation of the authorization documents performed by the RDFI as part of the payments network, according to an example embodiment of the invention.

### DETAILED DESCRIPTION OF THE INVENTION

### A. Overview of Invention.

For the purposes of this invention, “ACH” shall mean automated clearing house in its ordinary meaning in the ACH industry, “ODFI” shall mean originating depository financial institution in its ordinary meaning in the ACH industry, “RDFI” shall mean receiving depository financial institution” in its ordinary meaning in the ACH industry, and “TPPP” shall mean third-party payment processor in its ordinary meaning in the ACH industry. The term “advance” refers to a credit to a bank account and the term “collection” refers to a debit to a bank account.

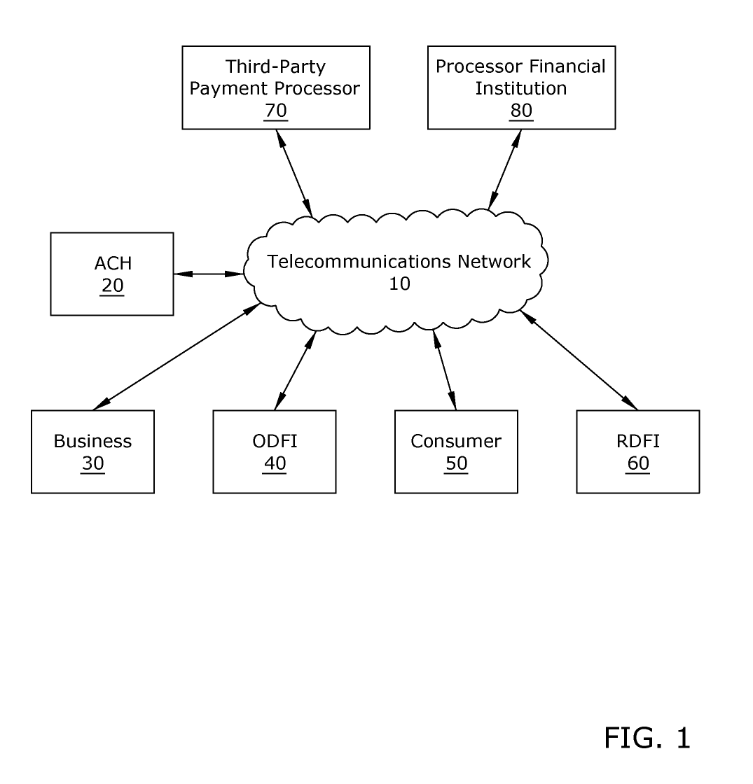

FIGS. 1 through 11 illustrate the present invention. The electronic funds transfer consumer authorization verification system generally includes accepting by a business 30 an authorization from a consumer 50 to debit and/or credit the consumer's financial account in a specified amount via an ACH network, communicating the ACH detailed record for the ACH transaction along with a transaction data file from the business 30 to a third-party payment processor 70, and communicating to the business 30 a unique transaction key associated with both the ACH detailed record and the transaction data file. The transaction key may be comprised of any format capable of identifying the ACH transaction separately from other ACH transactions thereby allowing association of the transaction data uploaded by the business 30 to the third-party payment processor 70 to be connected to one another in a database. The transaction data file is an image data file that may be comprised of an ACH authorization signature or statement by the consumer 50 authorizing the ACH transaction, a copy of the identification documents for the consumer 50 and/or state licensing information for the business 30. If the ACH transaction is denied such as for no authorization by the consumer 50, the business 30 and the third-party payment processor 70 have evidence via the transaction data file that the consumer 50 authorized the ACH transaction. In addition, the RDFI 60 will have the ability to access and view the transaction data file for each ACH transaction passed on a factored authentication method provided by the system.

### B. Exemplary Telecommunications Network(s).

The present invention may be utilized upon any telecommunication network 10 capable of transmitting electronic data and/or electronic funds between a plurality of electronic devices (e.g. computers, mobile devices, etc.). The present invention may communicate via a single telecommunication network 10 or multiple telecommunication networks 10 concurrently. In particular, the devices for each entity such as a computer for the business 30, a computer for the originating depository financial institution (ODFI 40) 40, a computer for the consumer 50, a computer for the receiving depository financial institution (RDFI) 60, a computer for the automated clearing house 20 (ACH), and a computer for the third-party payment processor (TPPP) 70 communicate with one another via one or more networks as illustrated in FIG. 1 of the drawings.

Examples of suitable telecommunication networks 10 for the present invention include, but are not limited to, global computer networks (e.g. Internet), closed computer networks (a.k.a. intranets), financial networks, interbank networks (a.k.a. ATM consortium or ATM network), wireless networks, telephone networks, cellular networks, satellite communications networks, cable communication networks (e.g. via a cable modem), microwave communications network, local area networks (LAN), wide area networks (WAN), campus area networks (CAN), metropolitan-area networks (MAN), and home area networks (HAN). Various protocols may be utilized by the electronic devices for communications such as but not limited to HTTP, SMTP, FTP and WAP (wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary communications network for the present invention. The Internet is basically comprised of a “global computer network.” A plurality of computer systems around the world are in communication with one another via this global computer network and are able to transmit various types of data between one another. The communications between the computer systems may be accomplished via various methods such as but not limited to wired, wireless, Ethernet, cable, direct connection, telephone lines, and satellite.

### C. Consumer.

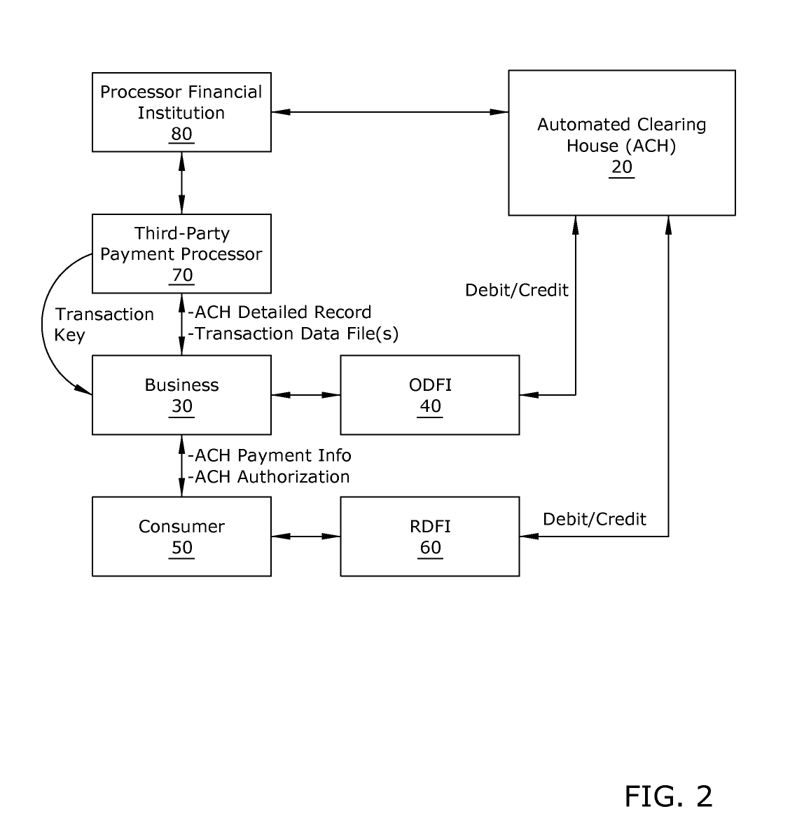

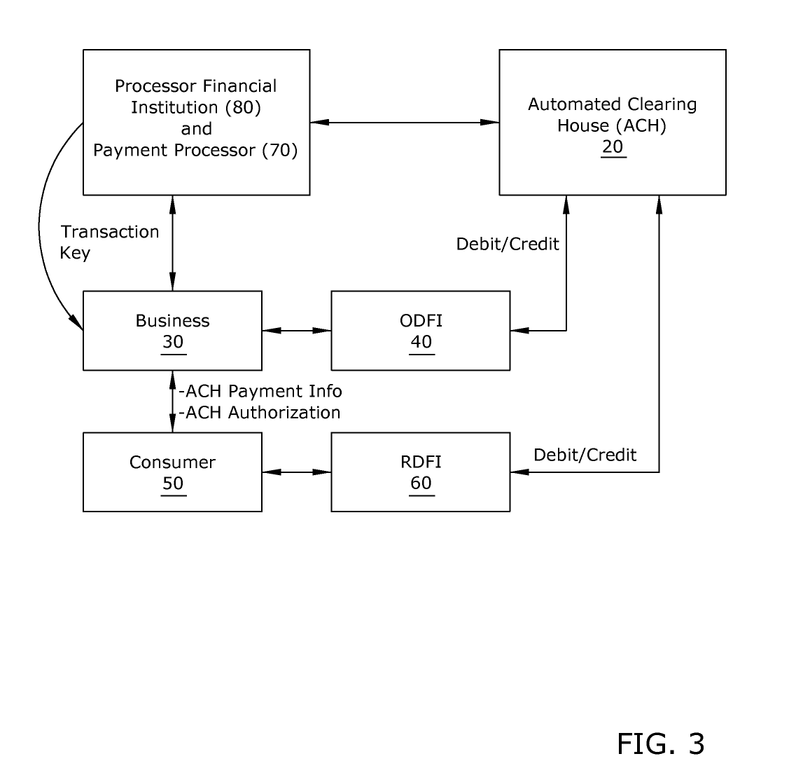

The consumer 50 may be any individual or legal entity that is authorizing an ACH transaction with the business 30. The consumer 50 may authorize the ACH transaction at a physical location for the business 30 by signing an ACH authorization form (a.k.a. Credit/Debit Authorization Form) with their signature (e.g. handwritten signature or a digital signature) or via a computer such as online via the network. The consumer 50 also provides various other information required by the business 30 such as the legal name of the consumer 50, state of residency, residential address, amount of the credit or debit, a maximum amount for the credit or debit, a routing number for the financial institution for the consumer 50, a checking/savings account number at the financial institution for the consumer 50 where funds are to be credited or debited, copy of driver's license, copy of Social Security card, picture taken of the consumer 50 by the business 30 and the like. The business 30 enters the information received from the consumer 50 into a database that stores the information for later access. The financial institution for the consumer 50 is the RDFI 60 as illustrated in FIGS. 2 and 3 of the drawings.

### D. Business.

The business 30 may be comprised of any entity that needs to credit and/or debit a consumer's financial account. The business 30 may be comprised of various entities including, but not limited to, merchants, online retailers, financial institutions, banks, credit unions or payday lenders. The financial institution for the business 30 is the ODFI 40 as illustrated in FIGS. 2 and 3 of the drawings.

A computer at the business 30 is utilized by the business 30 to store consumer 50 information, fund transfer information, payment information, purchase information, ACH payment information, ACH authorization and various other types of electronic information relating to electronic funds transfer. The computer for the business 30 also communicates with the computer of the third-party payment processor 70, the computer for the ODFI 40 and/or the computer for the RDFI 60 via the network. The computer for the business 30 is comprised of an electronic device capable of receiving, transmitting and storing electronic data.

### E. ODFI, RDFI and Processor Financial Institution.

The ODFI 40 is the financial institution for the business 30, the RDFI 60 is the financial institution for the consumer 50 and the processor financial institution 80 is the financial institution for the third-party payment processor 70. The ODFI 40 has a financial account for the business 30 with where funds may be transferred to and from, the RDFI 60 has a financial account for the consumer 50 with where funds may be transferred to and from, and the processor financial institution 80 has a financial account for the third-party payment processor 70 with where funds may be transferred to and from. Each financial account has a financial institution routing number and account number associated with it for facilitating the transfer of funds to and from thereof

The ODFI 40, the RDFI 60 and the processor financial institution 80 may each be comprised of various financial entities such as but not limited to a bank, a mortgage loan company or credit union. The financial accounts for the business 30, consumer 50 and the third-party payment processor 70 may also be comprised of various financial accounts such as but not limited to a checking account, a savings account, business 30 account, a debit card account or a pre-paid debit account.

As shown in FIG. 3, the processor financial institution 80 and the payment processor may be comprised of the same entity such as a bank providing payment processing for its customers. There is no separate entity for the processor financial institution 80 and the third-party payment processor 70 in this situation as further shown in FIG. 3 of the drawings.

### F. Third-Party Payment Processor.

The third-party payment processor 70 is any business 30 that facilitates the electronic exchange, transfer of funds from one financial account to another financial account within a single financial institution or across multiple financial institutions. The third-party payment processor 70 electronically transfers the funds via a computer-based system. The third-party payment processor 70 may transfer the money in various manners including bank wire transfers, an automated clearing house 20 (ACH) or interbank transfer. The third-party payment processor 70 may be a separate entity having a separate processor financial institution 80 (see FIG. 2) or an entity that is the same as the processor financial institution 80 (see FIG. 3).

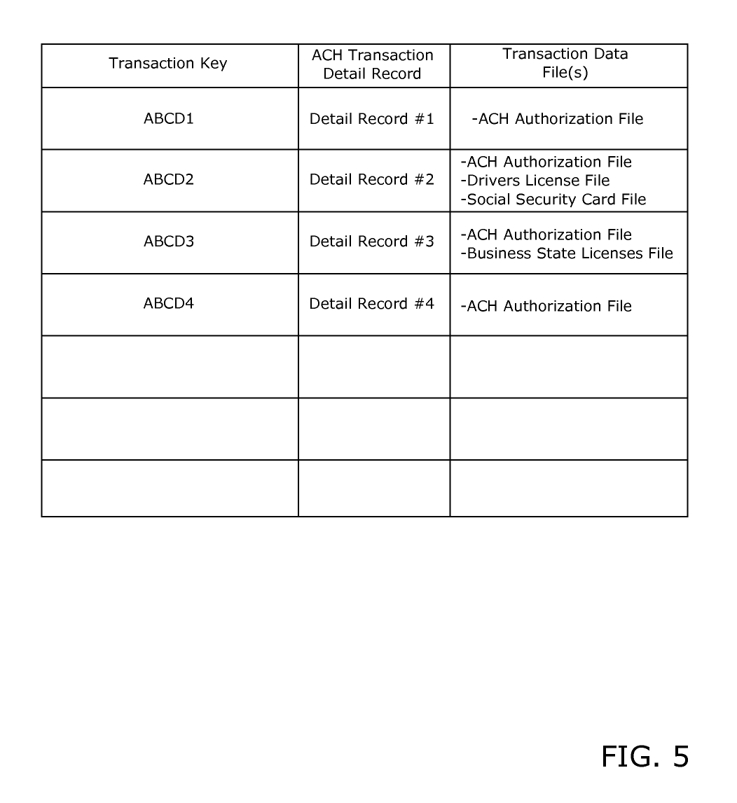

The third-party payment processor 70 determines what the unique transaction key is for each ACH transaction that corresponds to one or more transaction data files. The third-party payment processor 70 communicates the transaction key to the business 30 via the network so the business 30 (or any third-party the business 30 gives the transaction key to such as the RDFI 60 or the ODFI 40) can access the ACH detail record and the transaction data files associated with the ACH detail record. FIG. 5 illustrates an exemplary database table illustrating the usage of a simple transaction key for both an ACH transaction detail record and the transaction data file(s). The third-party payment processor 70 stores the transaction key, the ACH transaction detail record and the corresponding transaction data files in a database on a computer for the third-party payment processor 70. The transaction key is entered into the individual identification field in the entry detail record for the ACH transaction by the business 30. If the business 30 provides an entry detail record without a transaction key, the third-party payment processor 70 provides the transaction key to the business 30 after receiving the ACH transaction detail record for the business 30 to use with any transaction data files uploaded to the third-party payment processor 70.

For the present invention, it is preferable that the money is transferred via an ACH network in ACH batches. The ACH transaction is accomplished with the help of an automated clearing house 20 such as the Federal Reserve or the Electronic Payments Network a.k.a. EPN which is operated by The Clearing House Payments Company.

### G. ACH Batch File and ACH Detail Records.

An ACH batch file or ACH file is comprised of one or more ACH detail records. The ACH file is an electronic data file that stores the entry detail records for the ACH transactions. Each ACH detail record corresponds to an ACH transaction for the business 30.

A conventional ACH file is a simple ASCII-format file that adheres to the Automated Clearing House specifications. “ASCII” stands for the American Standard Code for Information Interchange that is based on the English alphabet that encodes 128 specified characters comprised of the numbers 0-9, the letters a-z, the letters A-Z, some basic punctuation symbols, some control codes and a blank space into the 7-bit binary integers. Because the ACH file is only an ASCII-format file, the ACH file is only able to communicate text data and not image data that store digital image data in image file formats such as, but not limited to, portable document format (PDF) file format, JPEG file format, graphics interchange format (GIF) file format, TIFF file format, portable network graphics (PNG) file format and the like.

A single ACH file holds one or more electronic transactions, much like a manila file folder that is used to store and transmit dozens of sheets of paper with information related to a single topic. Each transaction within an ACH file carries either a credit or a debit value.

The ACH file typically is comprised of a file header record (e.g. name of the business 30, company number, ODFI 40), a batch header record (e.g. effective entry date, identification of business 30, entry description for the credit and debits in the batch), one or more entry detail records (the information necessary to post a deposit to/withdrawal from an account, such as recipient's name, account number, dollar amount of the payment) and a batch control record/total (this record appears at the end of each batch and contains totals for the batch). NACHA sets the requirements for the ACH batch file which is currently composed of 94 character records. The ACH file may include one or more batches of ACH transactions.

The entry detail record in the ACH batch file includes various fields such as record type code, transaction code, identification of RDFI 60, identification of the ODFI 40, check digit, DFI account number, funds transfer amount, individual identification, individual name (e.g. name of consumer 50), discretionary data, addenda record indicator and trace number. The present invention utilizes the individual identification field (a.k.a. individual ID or individual identification number field) to receive, store and transmit the unique transaction key for each ACH transaction to associate the ACH transaction entry detail record with one or more transaction data files provided by the business 30 to the third-party payment processor 70.

After the business 30 receives the authorization for the ACH transaction and other required information from the consumer 50, the business 30 can either include the ACH transaction detail record by itself in an ACH file that is uploaded to the third-party payment processor 70 or the ACH transaction detail record can be included in a batch of other ACH transaction detail records that are uploaded together in a single ACH batch file at the end of the day (or other scheduled time). If the business 30 uploads the ACH transaction detail record as a single ACH transaction detail record in the ACH file to the third-party processor 70, the business can also at the same time upload the corresponding transaction data file(s) associated with the ACH transaction detail record.

The financial account routing number and the account number for the consumer 30 in the ACH transaction detail record is also included in the transaction data file(s) thereby allowing the third-party payment processor to match up the ACH transaction detail record with the corresponding transaction data file(s) associated therewith. This matching process is used for a single ACH transaction detail record included in an ACH file or a plurality of ACH transaction detail records included in an ACH file.

### H. Transaction Data File(s).

The business 30 communicates one or more transaction data files that correspond to an individual ACH transaction detail record that the business transmits at the same time or after the transaction data files. The transaction data files include image data and other information that cannot be transmitted via the ACH file which is only an ASCII-format file. The business 30 provides the transaction data files to the third-party payment processor 70 by a secure telecommunication network 10 which may be accomplished by the business 30 accessing a webpage, using file transfer protocol (FTP) or other electronic file transfer system capable of transmitting image data files. The transaction data file(s) preferably include image information that proves authorization by the consumer 50 for the ACH transaction and that the business 30 is licensed to do business 30 in the state where the consumer 50 resides or is located.

The transaction data file(s) include image data that are stored on digital image data in various image file formats such as, but not limited to, portable document format (PDF) file format, JPEG file format, graphics interchange format (GIF) file format, TIFF file format, portable network graphics (PNG) file format and the like. Examples of transaction data files that are transmitted by the business 30 to the third-party payment processor 70 include an ACH authorization by the consumer 50, a signature of the consumer 50 for the ACH authorization, a complete ACH authorization agreement signed by the consumer 50, a statement by the consumer 50 authorizing the ACH transaction, a copy of the driver's license for the consumer 50, a copy of the Social Security card for the consumer 50, an agreement for other types of transactions (e.g. a property agreement), a copy of a license in a state for the business 30 confirming that the business 30 is allowed to do business 30 in the state where the consumer 50 resides and various other types of documents desirable for verifying a transaction.

### I. Operation of Invention.

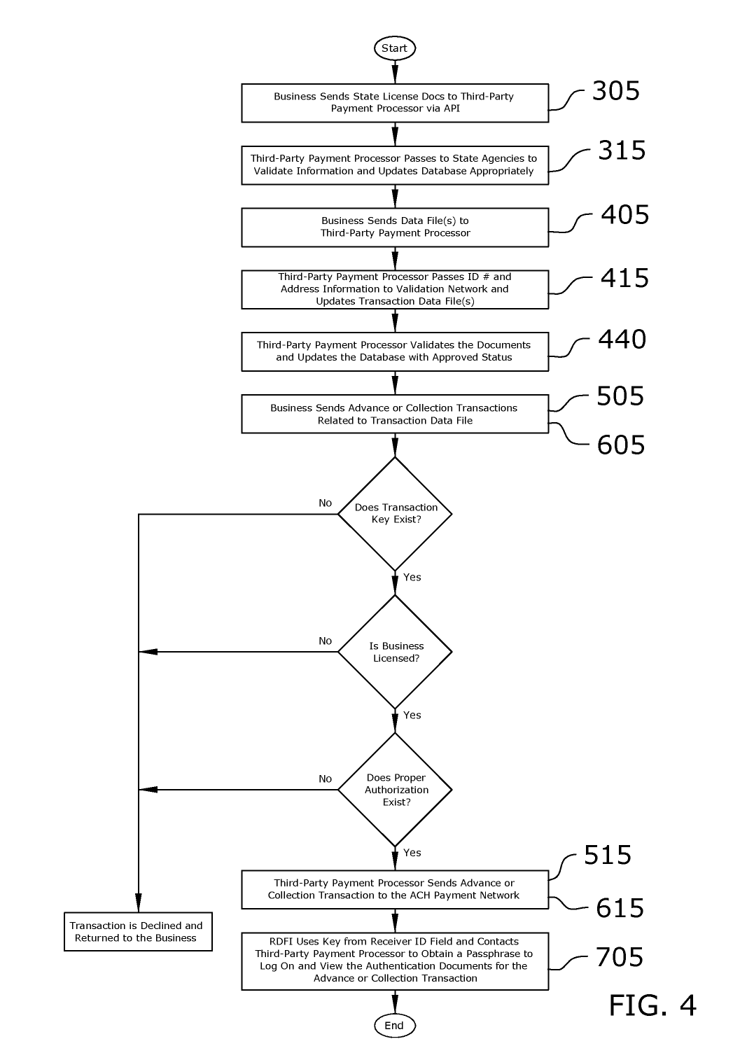

FIG. 4 provides an overview of the present invention. The business 30 sends one or more transaction data files to the third-party payment processor 70 such as a copy of a state license, a signature of the consumer 50, an ACH authorization by the consumer 50, a copy of an agreement with the consumer 50, and a copy of a driver's license or other identification for the consumer 50. The transaction data files are in a PDF or other image data file format for the third-party payment processor 70 to view.

The third-party payment processor 70 verifies via a state agency that the business 30 is authorized to do business 30 in the state alleged to be licensed. If the business 30 is verified by the third-party payment processor 70 to be licensed in a state, the third-party payment processor 70 then updates its database to include a unique transaction key that is associated with the transaction data file(s) provided by the business 30. The third-party payment processor 70 further attaches any additional transaction data files to the record associated with the transaction key to provide additional evidence of the business's verified licensing in a state for additional evidence of the business's ability to do business in a state (e.g. a copy of a document received from the state licensing agency). The third-party payment processor 70 further transmits the transaction key to the business 30 for use when the business 30 sends the ACH transaction detail record.

When the business 30 sends the ACH transaction detail record (a.k.a. entry detail record) to the third-party payment processor 70, the business 30 enters into the individual identification field for the detail record the transaction key provided by the third-party payment processor 70. When the third-party payment processor 70 receives the ACH transaction detail record which includes the transaction key, the third-party payment processor 70 via computer associates the ACH transaction detail record with the corresponding transaction data file(s) that have the same transaction key.

For example, if the transaction key for a transaction data file comprised of an ACH authorization file is ABCD1 and the transaction key for the ACH transaction detail record for Detail Record #1 is ABCD1, the database on the computer for the third-party payment processor 70 associates the same together as illustrated in FIG. 5 of the drawings. Each transaction key is preferably used only once for a single ACH transaction. The third-party payment processor 70 then batch processes the ACH transactions as they normally would through the automated clearing house 20 where the automated clearing house 20 (e.g. Federal Reserve) credits/debits the ODFI 40 and debits/credits the RDFI 60 accordingly to transfer the funds as requested by the ACH authorization by the consumer 50. The transaction key may be comprised of any type of data such as text data, letters, numbers, characters, non-text data and any combination thereof.

If there is a dispute as to the validity of the ACH transaction (e.g. a dispute as to whether the consumer 50 actually authorized the ACH transaction), the business 30 and/or third-party payment processor 70 can easily identify and view the transaction data files associated with the ACH transaction using the transaction key. The transaction data files may be accessed and viewed via a web interface hosted by the third-party payment processor 70. In addition, the transaction key and a password may be provided to the RDFI 60 or the ACH to log into a web page for the third-party payment processor 70 to access the transaction data files associated with the transaction key (and the corresponding ACH transaction). The ACH transaction can then be verified (or not verified) based upon the transaction data files without the business 30 (or the third-party payment processor 70) having to gather and fax the transaction data files. In addition, the RDFI 60 does not have to try to determine what ACH transaction the incoming transaction data file sent via a fax or email is supposed to be associated with.

As shown in FIG. 4, if no transaction key is provided by the business 30, then the transaction is declined and returned to the business 30. In addition, if the business 30 is not licensed in the state where the consumer 50 resides, the transaction is declined and returned to the business 30. Finally, if the proper authorization does not exist in the transaction data files, the transaction is declined and returned to the business 30.

### J. Additional Information for Operation of Invention.

This following section of the patent application does not limit the scope of the prior section of this document in any manner and instead merely supplements with additional information what has been previously discussed. Embodiments of the invention may provide systems and methods for facilitating authorized business-to-consumer transactions, business-to-business transactions or consumer-to-consumer transactions. In one example embodiment, a state licensed business 30 accepts authorization documents from consumers 50. The documents indicate that the consumer 50 will allow the business 30 to transact money to and from said consumer's bank account. These documents are then sent in a “data envelope” comprised of one or more transaction data files to the third-party payment processor 70. The third-party payment processor 70 then passes back a unique transaction key to the business 30 that is associated with both the ACH transaction (including the ACH transaction detail record) and the transaction data file(s).

The third-party payment processor 70 attempts to validate all of information that was passed and provided in the transaction data envelope. If the transaction data envelope is valid, the business 30 passes back to the third-party payment processor 70 the transaction key along with instructions on whether to debit or credit a consumer's bank account when said business 30 approves a transaction for said consumer 50. This sensitive information is to be stored in a Payment Card Industry (aka PCI) level 1 environment. This environment maintains the highest level of compliance and encryption within the Payment Card Industry. Once the business 30 passes the advance or collection transaction to the third-party payment processor 70; there are a number of checks done to verify information before sending the transaction to the payments network. The transaction data envelope has to exist. The merchant has to be licensed in the state that the consumer 50 resides. There must be a valid consumer 50 authorization document on file. The routing number, account number, and payment amount must match the initial transaction data envelope that was setup. Once all of the requirements are met, the transaction is sent to the ACH payments network with payment instructions.

As used herein, the term “consumer” generally refers to an individual that will receive an advance or pay a collection to a business entity. As such, the consumer must have given authorization using a transaction data envelope to receive an advance or pay a collection via this system. As used herein, the term “business” generally refers to an entity that accepts a consumer's information and delivers transaction data envelopes and instructions into this system. The business will approve the advance or the collection of funds from the consumer through the use of this system. The business will also engage in a transaction only with consumers residing in the state that the business is licensed.

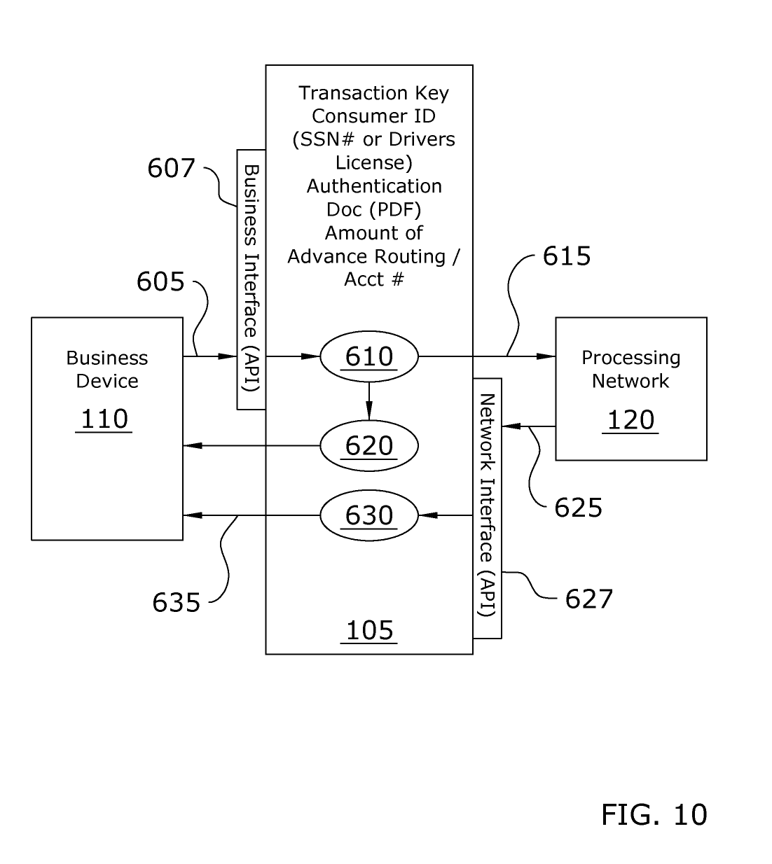

FIG. 10 illustrates an example system 100 for facilitating business-to-consumer payments, according to an example embodiment of the invention. Although various computing devices and/or computers are illustrated in FIG. 10, it is appreciated that corresponding entities and/or individuals are associated with each of the computers illustrated. According to various embodiments, there will be one third-party payment processor 70, associated with one or more TPPP computers 106, each associated with one or more suitable business devices 110 (e.g., computers, mobile devices); one or more consumer devices 115 (e.g., computers, mobile devices); and one or more payment processing networks 120 that are associated with one or more Network computers 127. According to various embodiments, there may be any number of each entity type, and each entity type may be associated with any number of suitable computers, computing devices, and/or other devices. For simplicity, the computers, devices, and/or entities may be referenced in the singular, but it is appreciated that the same description applies to embodiments including multiple computers, devices and/or entities. Similarly, for each of the computers described herein, it is appreciated that the computer may include any number of suitable components and/or functionality.

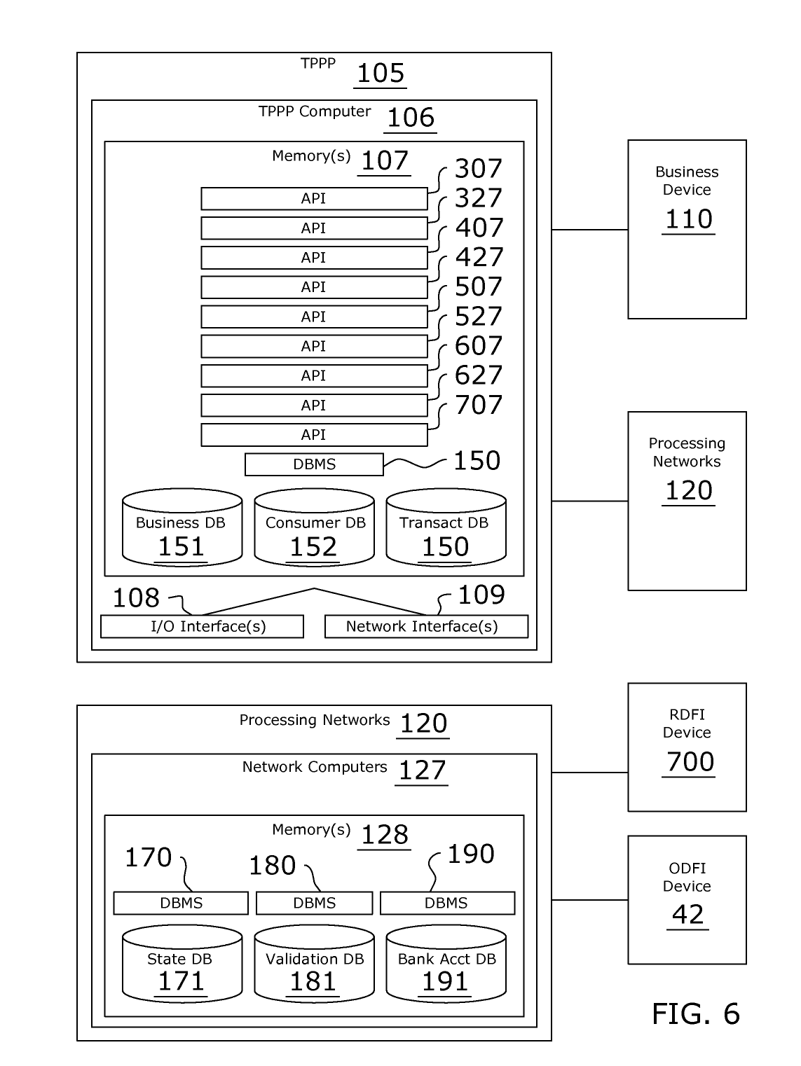

As shown in FIG. 6, one third-party payment processor 70, a business device 110, a processing network 120, an ODFI device 42 and/or RDFI device 700 may be in communication with each other via any number of suitable networks, which, as described below, can include one or more separate or shared private and/or public networks, including the Internet or a publicly switched telephone network. More specifically, according to various embodiments, the third-party payment processor 70 may receive requests from a business device 110. The third-party payment processor 70 may send requests to a processing network 120. The third-party payment processor 70 may receive requests from a RDFI device 700 and send information back to the RDFI via a processing network 120.

As shown in FIG. 6, each TPPP computer 106 may include one or more memory devices 107, one or more input/output interfaces 108, and one or more network interfaces 109. The memory device 107 may be any suitable memory device, for example, caches, read only memory devices, random access memory devices, magnetic storage devices, removable storage devices, etc. There may be any number of logical data storage constructs as desired.

As shown in FIG. 6, each TPPP computer 106 may include each of the API executable files for processing transactions 307, 327, 407, 427, 507, 527, 607, 627, 707. In addition, each TPPP computer 106 may include each of the database containers for the storage of business 151, consumer 152, and transactions 153. The API files communicate with the database containers via the database management system (DBMS) 150.

The API 307 will be programmed to accept input from a business using a business device 110. This input will be to send state licensing agreements into the third-party payment processor 70 for validating the state licensing requirements. The API 327 will be programmed to accept input from a state agency website 130. This input will be to validate that a business is licensed in that said state. The API 407 will be programmed to accept input from a business device 110. This input will be to send consumer authorization transaction data envelopes to the third-party payment processor 70. The API 427 will be programmed to accept input from a consumer ID and address validation network 140. This input will be to validate identification numbers and addresses of consumers. The API 507 will be programmed to accept input from a business device 110. This input will be to accept a request to transact an advance from a business to a consumer with reference to the consumer transaction data envelope. The API 527 will be programmed to accept input from a processing network 120. This input will be to accept a return or correction from the processing network 120. The API 607 will be programmed to accept input from a business device 110. This input will be to accept a request to transact a collection from a business to a consumer with reference to the consumer transaction data envelope. The API 627 will be programmed to accept input from a processing network 120. This input will be to accept a return or correction from the processing network 120. The API 707 will be programmed to accept input from a RDFI device 700. This input will be to accept a request from the RDFI for authorization documents that are pertaining to a specific transaction data envelope transaction. There is data storage at 105, 150 with 151, 152, 153 and data storage at 120, 170 with 171, 180 with 181, 190 with 191.

Those of ordinary skill in the art will appreciate that the system 100 shown in and described with respect to FIG. 10 is provided by the way of example only. Numerous other operating environments, system architectures, and devices configurations are possible. Other system embodiments can include fewer or greater numbers of components and may incorporate some or all of the functionality described with respect to the system components shown in FIG. 10. Accordingly, embodiments of the invention should not be construed as being limited to any particular operating environment, system architecture, or device configuration.

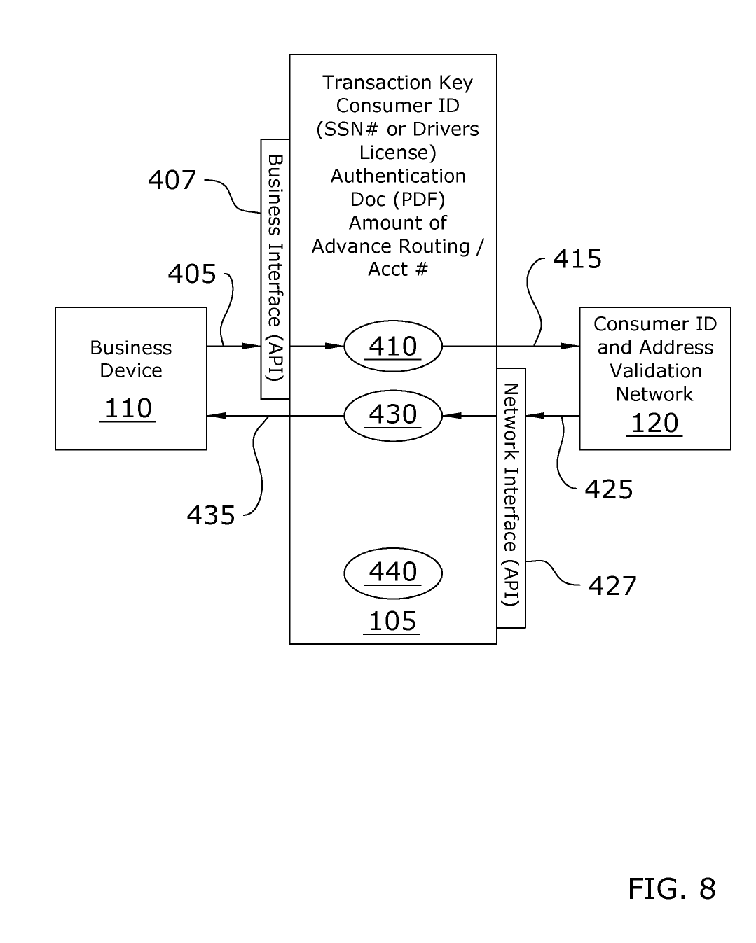

FIG. 8 is a flow chart of an example method 200 for facilitating an authorized business-to-consumer advance or collection, according to an example embodiment of the invention. In certain embodiments, the operations of the method 200 may be performed by one or more TPPP computers 106 associated with the third-party payment processor 70.

At block 305, a business using a business device 110, sends state license documents to the third-party payment processor 70. The information pertaining to a business is found in the business DB 151 found on the TPPP computer 106. At block 315, the third-party payment processor 70 passes information to a state agency website 130 to validate the business is licensed in said state. The state agency website 130 then responds with a positive or negative response.

At block 405, the business 110 sends a consumer transaction data envelope to the third-party payment processor 70. This transaction data envelope contains identification numbers, address information, bank account information, and documents supporting an authorization. This authorization proves that the consumer wants to allow the business to advance or collect money from said consumer bank account.

At block 415, the TPPP sends a request to the consumer ID and address validation network 140. This request is validated and the database 152 is updated.

At block 440, the TPPP validates the documents associated with the consumer transaction data envelope in database 152 and updates the database with approved or un-approved status.

At block 505, the business sends advance instructions to the third-party payment processor 70. These advance instructions point to a specific consumer transaction data envelope residing in the database 152.

At block 605, the business sends collection instructions to the third-party payment processor 70. These collection instructions point to a specific consumer transaction data envelope residing in the database 152.

The method 200 may end following block 505 or 605 if any one of the following conditions are not met. If a transaction data envelope doesn't exist for the transaction in 505 or 605, the method 200 will terminate. Secondly, if the business is not licensed in the state where the consumer claims residency for the transaction in 505 or 605, the method 200 will terminate. Lastly, if the consumer doesn't provide proper authorization documents for the transaction in 505 or 605, the method 200 will terminate.

Otherwise, at block 515, the third-party payment processor 70 sends advance transaction to the processing network 120. Or, at block 615, the third-party payment processor 70 sends collection transaction to the processing network 120. At block 705, the RDFI device 700 sends the transaction data envelope key and a passphrase to the third-party payment processor 70. The third-party payment processor 70 will then send back any authorization documents stored in the database 152 associated with the requested transaction data envelope.

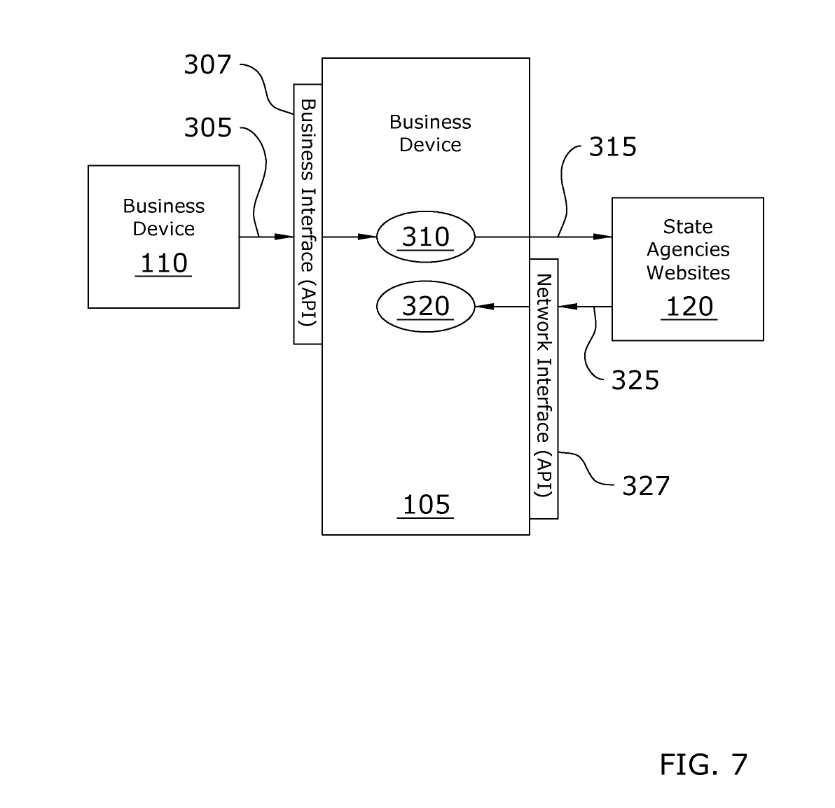

FIG. 7 is a flow chart of data flows for the business sending state licensing agreements to the third-party payment processor 70 for facilitating authorized business-to-consumer transactions, according to an example embodiment of the invention. In reference to FIG. 7, a business document transmission 305 may be received by the third-party payment processor 70 from a business device 110 from a business illustrated in FIG. 6. The data is stored in the business database 151 via procedure 310. A request 315 is then sent to a state agency website 130 to validate the business is licensed to do business in said state. The state agency website 130 responds with a positive or negative response to the third-party payment processor 70 via the procedure 327 API call and updates the Business Database 151 via the procedure 330.

FIG. 8 is a flow chart of data flows for the business sending consumer transaction data envelopes to the third-party payment processor 70 for facilitating authorized business-to-consumer transactions, according to an example embodiment of the invention. In reference to FIG. 8, an transaction data envelope transmission 405 may be received by the third-party payment processor 70 from a business device 110 via the 407 API call from a business illustrated in FIG. 6. The data is stored in the consumer database 152 via procedure 410. A request 415 is then sent to a consumer ID and address validation network 140 to validate the ID and the address of residence for the consumer.

The consumer ID and address validation network 140 responds with a positive or negative response to the third-party payment processor 70 via the procedure 427 API call and updates the Consumer Database 152 via the procedure 430. A response is then supplied to the business device 110 via procedure 435. Then, a business analyst at the third-party payment processor 70 will validate all documents associated with the transaction data envelope that has been sent via the procedure 440.

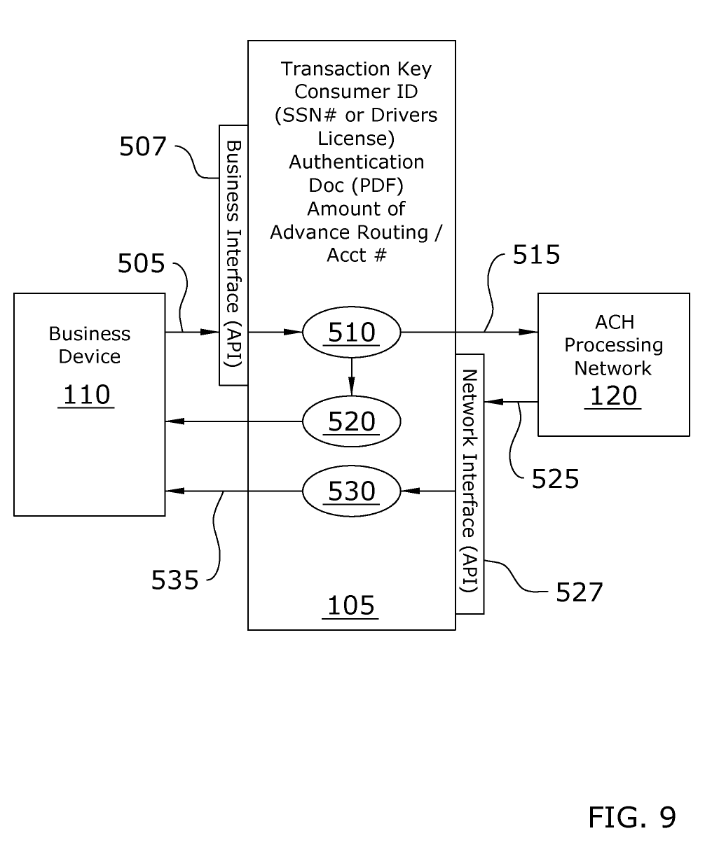

FIG. 9 is a flow chart of data flows for the business sending advance transactions to the third-party payment processor 70 for facilitating authorized business-to-consumer advance transactions, according to an example embodiment of the invention. In reference to FIG. 9, an advance transmission 505 may be received by the third-party payment processor 70 from a business device 110 via the 507 API call from a business illustrated in FIG. 6. The data is stored in the transact database 153 via procedure 510. If the transaction data envelope exists, and the business is licensed in the state that the consumer resides, and the proper authorization exists, then a request 515 is then sent to the processing network 120. If a transaction data envelope doesn't exist or the business is not licensed in the state that the consumer resides or the proper authorization doesn't exist, then the procedure 520 responds back to the business device 110 with a notification. If the processing network returns the item via procedure 525 through the 527 Network API call to the third-party payment processor 70; then procedure 530 responds to the business device 110 with a report via the 535 procedure.

FIG. 10 is a flow chart of data flows for the business sending collection transactions to the third-party payment processor 70 for facilitating authorized business-to-consumer collection transactions, according to an example embodiment of the invention. In reference to FIG. 10, a collection transmission 605 may be received by the third-party payment processor 70 from a business device 110 via the 607 API call from a business illustrated in FIG. 6. The data is stored in the transact database 153 via procedure 610. If the transaction data envelope exists, and the business is licensed in the state that the consumer resides, and the proper authorization exists, then a request 615 is then sent to the processing network 120. If a transaction data envelope doesn't exist or the business is not licensed in the state that the consumer resides or the proper authorization doesn't exist, then the procedure 620 responds back to the business device 110 with a notification. If the processing network returns the item via procedure 625 through the 627 Network API call to the third-party payment processor 70; then procedure 630 responds to the business device 110 with a report via the 635 procedure.

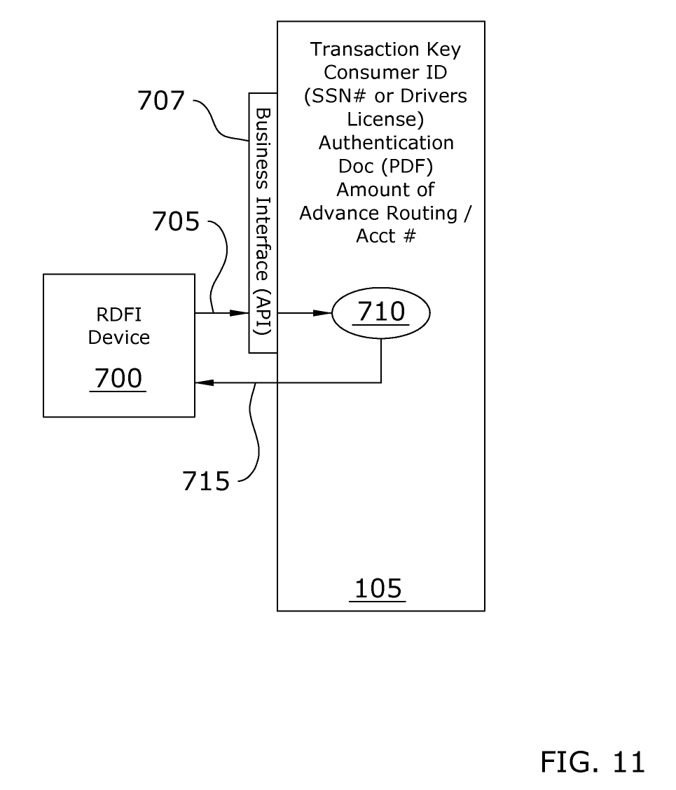

FIG. 11 is a flow chart of data flows for the RDFI looking up authorizations for transactions sent through the third-party payment processor 70, according to an example embodiment of the invention. In reference to FIG. 11, an RDFI device 700 sends a request 305 may be received by the third-party payment processor 70 via API call 707 from a business illustrated in FIG. 6. The data is retrieved from the consumer database 151 and the transact database 153 via procedure 710. A response 715 with supporting data is then sent back to the RDFI device 700 via procedure 715.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method of verifying an electronic funds transfer, said method comprising:
receiving by a business from a consumer a transaction data for a financial transaction to debit and/or credit said consumer's financial account via a financial network;
receiving by said business from said consumer an authorization for said financial transaction;
creating a funds transfer file by said business that includes a detail record having financial information relating to said financial transaction;
creating at least one transaction data file that includes said authorization for said financial transaction;
transmitting said funds transfer file from a business computer to a payment processor computer for a third-party payment processor via a telecommunications network;
transmitting said transaction data file from a business computer to said payment processor computer for a third-party payment processor via a telecommunications network;
generating a transaction key by said third-party payment processor; and
storing said transaction key in a database that includes information for said detail record and information for said at least one transaction data file related to said detail record, wherein said transaction key relates to both said detail record and said at least one transaction data file, wherein said transaction key is unique for said detail record, and wherein said transaction key is utilized to access said at least one transaction data file.

2. The method of claim 1, wherein said financial network is an automated clearing house network.

3. The method of claim 1, wherein said authorization is comprised of an agreement signed by said consumer with a signature.

4. The method of claim 3, wherein said signature is comprised of a handwritten signature.

5. The method of claim 3, wherein said signature is comprised of an electronic signature.

6. The method of claim 1, wherein said at least one transaction data file is comprised of an image data file.

7. The method of claim 6, wherein said at least one transaction data file is comprised of a portable document format (PDF) file format.

8. The method of claim 6, wherein said at least one transaction data file is comprised of a first data file having an agreement between said business and said consumer.

9. The method of claim 8, wherein said at least one transaction data file is comprised of a second data file having a state license certification for said business.

10. The method of claim 9, including the step of verifying said state license certification by said third-party payment processor.

11. The method of claim 6, wherein said funds transfer file is comprised of an ACH batch file, wherein said ACH batch file is comprised of an ASCII-format file.

12. The method of claim 11, wherein said step of transmitting said funds transfer file and said step of transmitting said transaction data file are done concurrently.

13. The method of claim 11, wherein said step of transmitting said transaction data file is performed before said step of transmitting said funds transfer file.

14. A method of verifying an electronic funds transfer, said method comprising:
receiving by a business from a consumer a transaction data for an ACH transaction to debit and/or credit said consumer's financial account via an automated clearing house;
receiving by said business from said consumer an authorization for said ACH transaction;
creating an ACH file by said business that includes a detail record having financial information relating to said ACH transaction, wherein said ACH file is comprised of an ASCII-format file;
creating at least one transaction data file that includes said authorization for said ACH transaction, wherein said at least one transaction data file is comprised of an image data file;
transmitting said ACH file from a business computer to a payment processor computer for a third-party payment processor via a telecommunications network;
transmitting said transaction data file from a business computer to said payment processor computer for a third-party payment processor via a telecommunications network;
generating a transaction key by said third-party payment processor; and
storing said transaction key in a database that includes information for said detail record and information for said at least one transaction data file related to said detail record, wherein said transaction key relates to both said detail record and said at least one transaction data file, wherein said transaction key is unique for said detail record, and wherein said transaction key is utilized to access said at least one transaction data file.

15. The method of claim 14, wherein said authorization is comprised of an agreement signed by said consumer with a signature, wherein said signature is comprised of a handwritten signature or an electronic signature.

16. The method of claim 14, wherein said at least one transaction data file is comprised of a portable document format (PDF) file format.

17. The method of claim 14, wherein said at least one transaction data file is comprised of a first data file having an agreement between said business and said consumer and a second data file having a state license certification for said business.

18. The method of claim 14, including the steps of:
verifying said state license certification by said third-party payment processor;
approving said ACH transaction and transmitting said detail record to said automated clearing housing if said step of verifying said state license certification is validated; and
declining said ACH transaction and notifying said business if said step of verifying said state license certification is not validated.

19. The method of claim 14, wherein said step of transmitting said transaction data file is performed before said step of transmitting said funds transfer file.

20. The method of claim 19, wherein business inputs said transaction key into an individual identification field within said detail record prior to said step of transmitting said ACH file.
